(19) United States
(12) Patent Application Publication
(10) Pub. No.: US 2017/0108351 A1
(43) Pub. Date: Apr. 20, 2017

(54) POWER USAGE ESTIMATION DEVICE AND PROGRAM

(71) Applicant: PANASONIC INTELLECTUAL PROPERTY MANAGEMENT CO., LTD., Osaka (JP)

(72) Inventor: Noriyoshi SHIMIZU, Osaka (JP)

(21) Appl. No.: 15/317,096

(22) PCT Filed: Jul. 1, 2015
(86) PCT No.: PCT/JP2015/003303

§ 371 Date: Dec. 7, 2016

(30) Foreign Application Priority Data
Aug. 4, 2014 (JP) 2014-158505
Jan. 20, 2015 (JP) 2015-008669

(51) Int. Cl. G01D 4/00; H04Q 9/00

(52) U.S. Cl. CPC G01D 4/002; H04Q 9/00; G06Q 50/06

(57) ABSTRACT

A power usage estimation device includes an acquisition unit, a first storage unit, an analysis unit, an estimation unit, and a second storage unit. The first storage unit stores pieces of power information each including a corresponding one of power values acquired by the acquisition unit and a day and a time which are associated with the corresponding one of the power values. The analysis unit classifies one or more pieces of power information satisfying a predetermined condition, of the pieces of power information stored in the first storage unit per day, into one of groups which corresponds to the predetermined condition. The estimation unit estimates power usage of a branch circuit by comparing the one or more pieces of power information of the groups stored in the second storage unit between a plurality of days having identical attributes.

### TECHNICAL FIELD

The present invention relates to power usage estimation devices and programs, and more specifically to a power usage estimation device configured to estimate power usage based on a power value measured in an electric circuit and a program which enables a computer to function as the power usage estimation device.

### BACKGROUND ART

A technique has been proposed in which a power consumption of each of a plurality of electric appliances is measured and a similarity between a power consumption pattern and data of the measured power consumption of each electric appliance is calculated so as to detect an electric appliance in an on state (for example, see Document 1 “JP 2005-354794 A”).

The technique described in Document 1 uses the similarity to the power consumption pattern of each electric appliance to determine whether the electric appliance is in an on state or in an off state, and therefore, the power consumption pattern of each electric appliance has to be stored in advance. Therefore, an electric appliance cannot be determined whether it is in an on state or in an off state if its similarity is not stored in advance.

### SUMMARY OF INVENTION

It is an object of the present invention to provide a power usage estimation device capable of estimating power usage without using a power consumption pattern of each of electric appliances. It is also an object of the present invention to provide a program enabling a computer to function as the power usage estimation device.

A power usage estimation device according to the present invention includes: an acquisition unit configured to acquire, from a meter, power values of power passed through an electric circuit of a consumer facility; a first storage unit configured to store pieces of power information each including a corresponding one of the power values acquired by the acquisition unit and a day and a time which are associated with the corresponding one of the power values; an analysis unit configured to classify, one or more pieces of power information satisfying a predetermined condition, of the pieces of power information stored in the first storage unit per day, into one of groups which corresponds to the predetermined condition; a second storage unit configured to store the groups into which the pieces of power information are classified by the analysis unit; and an estimation unit configured to estimate power usage of the electric circuit by comparing the one or more pieces of power information of the groups stored in the second storage unit between a plurality of days having different attributes.

A program according to the present invention is configured to enable a computer to function as the power usage estimation device.

### BRIEF DESCRIPTION OF DRAWINGS

FIG. 1 is a block diagram illustrating a power usage estimation device of an embodiment;

FIG. 2 is a view illustrating a measurement example of power values of the embodiment;

FIG. 3 is a view illustrating an example of a frequency distribution of the power values of the embodiment;

FIG. 4 is a view illustrating an example of the frequency distribution after group extraction of the embodiment;

FIG. 5A is a view illustrating a transition example of a power value in one winter day of the embodiment, and FIG. 5B is a view illustrating a transition example of a power value in one autumn day of the embodiment;

FIGS. 6A and 6B are pie charts illustrating consumed energy;

FIG. 7 is a graph illustrating a measurement example of the power values of the embodiment;

FIG. 8 is a block diagram illustrating a configuration example of the power usage estimation device of the embodiment; and

FIG. 9 is a pie chart illustrating consumed energy of another configuration example of the embodiment.

### DESCRIPTION OF EMBODIMENTS

A power usage estimation device described below estimates power usage in an electric circuit of a consumer facility based on a transition of a measurement value (power value) of power passed through the electric circuit. That is, the embodiment described below uses changes in power value of the power passing through the electric circuit to estimate power usage, such as whether an apparatus connected to the electric circuit stationarily consumes power or consumption of power by the apparatus connected to the electric circuit is different from the consumption by the apparatus in a stationary state. Note that the consumer facility is a facility owned by a contractor who pays its electric fee or a person pursuant to the contractor. The electric circuit of the consumer facility is an electric circuit serving as an installation of the consumer facility and means, for example, an electric circuit constructed in a building of a detached house, an electric circuit constructed in a residential unit of a multiple residential dwelling complex, or an electric circuit constructed for each of tenants of office buildings or commercial buildings.

In the following description, an apparatus is assumed to be an electric appliance which consumes mainly electric power to achieve its function. Note that the technique of the present embodiment is applicable to apparatuses which consume fuel such as gas or apparatuses relating to a water system (water works or sewerage) while using electric power supplementarily or incidentally. The power usage estimation device is intended to be used in dwellings, but may be used in buildings other than the dwellings.

The electric circuit includes a main circuit and a branch circuit in the building. Power passing through the electric circuit is mainly assumed to be power passing through the branch circuit but may be power passing through the main circuit. There is a case where one electric appliance is connected to the branch circuit and a case where a plurality of electric appliances is connected to the branch circuit. The electric appliance may be stationarily or temporarily connected. The power passing through the electric circuit may be power passing through a socket (receptacle) into which a plug connected to the electric appliance is to be inserted or power measured by the electric appliance.

The power usage estimation device includes a computer as a main hardware configuration, and the computer executes a program to realize the following functions. Such a computer may be a personal computer or a portable terminal apparatus such as a smartphone or a tablet terminal. The computer may have a configuration as a microcontroller integrally including a processor and a memory.

The program may be written in advance in a Read Only Memory (ROM) of the computer or may be provided through an electric communication line such as the Internet. Alternatively, the program may be provided by computer-readable recording medium.

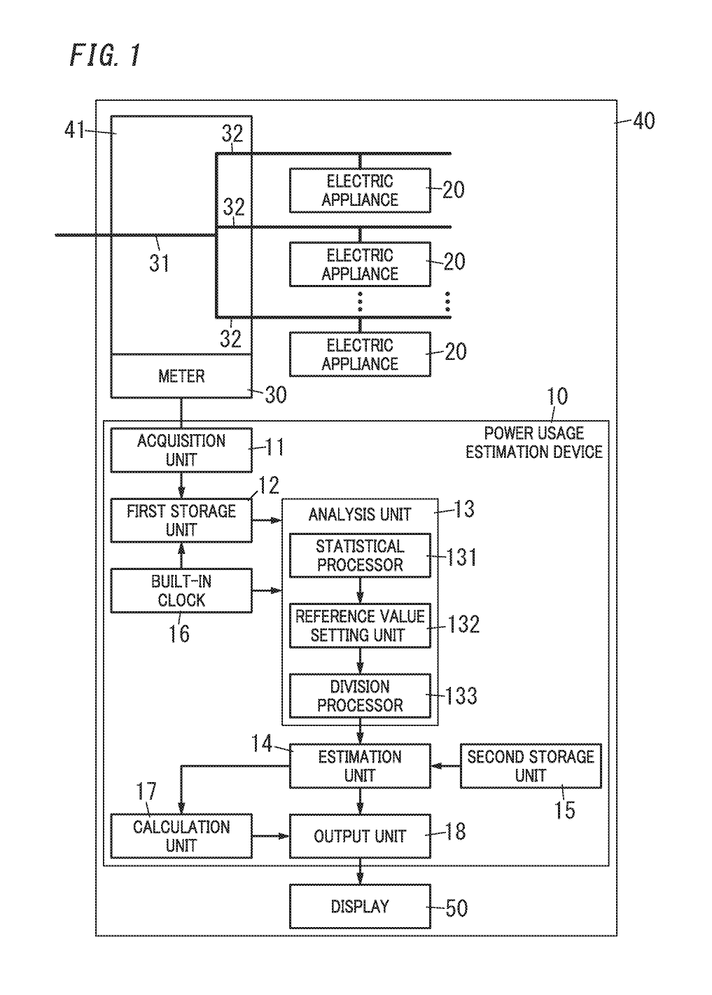

As illustrated in FIG. 1, a building 40 is provided with a distribution board 41 configured to distribute power. The distribution board 41 includes an electric circuit 31 of one system through which received power passes. The distribution board 41 branches the power passing through the electric circuit 31 in electric circuits 32 of a plurality of systems. The electric circuit 31 is hereinafter referred to as a “main circuit,” and the electric circuits 32 are referred to as “branch circuits.” The distribution board 41 may be configured to receive only a commercial power supplied from an electric power supplier, or to receive power from a distributed power supply (which is a photovoltaic generator, a power storage system, a fuel cell system, or the like) attached to the building 40.

In the distribution board 41 for dwellings, the main circuit 31 is in many cases configured as a bus bar (electrically conductive metal plate) electrically connected to a main breaker. The main circuit 31 is electrically connected to a plurality of branch breakers and branched into a plurality of systems, thereby forming the plurality of branch circuits 32.

A meter 30 measures power passing through the electric circuits 31 and 32 to which devices 20 (hereinafter referred to as “electric appliances”) are connected. The meter 30 measures power passing through each branch circuit 32. Note that the meter 30 may be configured to measure power passing through the main circuit 31 in addition to the power passing through each branch circuit 32. Alternatively, the meter 30 may be configured to measure only the power passing through the main circuit 31. The meter 30 is accommodated in the distribution board 41 or is disposed outside the distribution board 41.

When an electric circuit configured to supply power from the branch circuits 32 to the electric appliances 20 has receptacles, the meter 30 may be configured to measure power passing through each receptacle.

A case where the meter 30 is configured to measure power passing through each branch circuit 32 will be described below. Note that as described above, the technique described below is also applicable to a configuration in which power in an electric circuit other than the branch circuits 32 is measured.

The branch circuits 32 correspond to the electric appliances 20 on a one-to-one basis or in one-to-many relationship. That is, when the electric appliances 20 are, for example, air conditioners, Induction Heating (IH) cooking heaters, or microwave ovens which are apparatuses consuming relatively large amounts of power, the branch circuits 32 may correspond to electric appliances 20 on a one-to-one basis. Alternatively, when the branch circuits 32 correspond to the electric appliances 20 in one-to-many relationship, the branch circuits 32 are in many cases allocated to locations (rooms) as units in the building 40.

The meter 30 monitors, with regard to each of the branch circuits 32, a passing current by a Rogowski coil current sensor or a clamping current sensor and calculates an integrated value of a product of the value of the monitored current and a voltage value between lines of the branch circuit 32 as a power value. That is, a power value measured by the meter 30 is actually electric energy of each predetermined unit time but not an instantaneous power. The unit time is selected within the range of, for example, about 30 seconds to about 10 minutes, and preferably 30 seconds or 1 minute. The instantaneous power of each branch circuit 32 may vary over time even within the unit time, but in the present embodiment, variations in instantaneous power within the unit time are not taken into consideration, and integration electric energy in the unit time is used as the power value. The power value corresponds to an average value of power values in unit times.

A power usage estimation device 10 includes an acquisition unit 11 configured to acquire the power values of the branch circuits 32 measured by the meter 30. Each power value acquired by the acquisition unit 11 from the meter 30 is associated with a date and a time, and information including a combination of the power value, the date, and the time is stored in a first storage unit 12 as power information. The date and the time are measured by a built-in clock 16 such as a real time clock included in the power usage estimation device 10. The power information includes the power value of each unit time measured by the meter 30 and the date and the time measured by the built-in clock 16 at a time point at which the power value is acquired by the acquisition unit 11.

The first storage unit 12 has such capacity that is capable of storing power information through a time period longer than or equal to one year. The first storage unit 12 stores the power information of each branch circuit 32 and thus stores history of a transition of the power value of each branch circuit 32.

The power usage estimation device 10 uses the history of the transition of the power value of each branch circuit 32 stored in the first storage unit 12 to estimate power usage of the branch circuit 32. As described above, the power usage represents usage, such as whether the electric appliance 20 connected to the electric circuit stationarily consumes power or consumption of power by the electric appliance 20 connected to the electric circuit is different from the consumption by the electric appliance 20 in a stationary state. Therefore, the power usage is influenced by external conditions such as seasons, weather, and outdoor temperatures. Moreover, when a plurality of electric appliances 20 are connected to the branch circuit 32, evaluation of the power usage of the branch circuit 32 requires classification of pieces of power information of the electric appliances 20.

To classify the pieces of power information of the electric appliances 20, a predetermined comparison period has to be defined, and feature amounts have to be extracted from transitions of power values during the comparison period. Here, the feature amount means a time period during which each electric appliance 20 may be assumed to continuously operating and the power value of power consumed by the electric appliance 20. That is, during a time period from the appearance of a group described below to the disappearance of the group, a consumed power value representing the group is the feature amount.

In the present embodiment, the comparison period is defined as one day, but the comparison period can be accordingly defined. Note that when the comparison period is too short, the amount of information decreases and classifying the pieces of power information becomes difficult, and therefore, the comparison period is preferably longer than or equal to a half day. On the other hand, when the comparison period is too long, the power value of the power consumption may be varied due to, for example, the influence of seasons, and conditions defining the power value may increase, and therefore, an upper limit of about two weeks is preferably defined for the comparison period.

When the comparison period includes a plurality of days, attributes of the days such as the days of the week, months, seasons, outdoor temperatures, whether, and the like are preferably taken into consideration. That is, on days having identical attributes, the electric appliance 20 is assumed to be used in a similar manner. Therefore, extracting the feature amount by using the pieces of power information on days having the identical attributes is expected to result in a feature amount with few variations (little dispersion). The feature amount will be described later. Seasons may be sectioned by three months, but using calendrical sections of spring, summer, fall, and winter or sections according to solar terms (time periods obtained by dividing a year by 15 days into 24 sections) is more likely to reduce variations in feature amount.

The power usage estimation device 10 includes an analysis unit 13. The analysis unit 13 uses pieces of power information during the comparison period of the pieces of power information stored in the first storage unit 12 and extracts operation time periods based on changes in power value by operation of the electric appliances 20. Further, the analysis unit 13 classifies the pieces of power information into groups for each extracted operation time period depending on power values during the comparison period.

The analysis unit 13 includes a statistical processor 131, a reference value setting unit 132, and a division processor 133, and classifies pieces of power information including power values during the comparison period into groups according to the following procedures. Functions of the statistical processor 131, the reference value setting unit 132, and the division processor 133 will be described later.

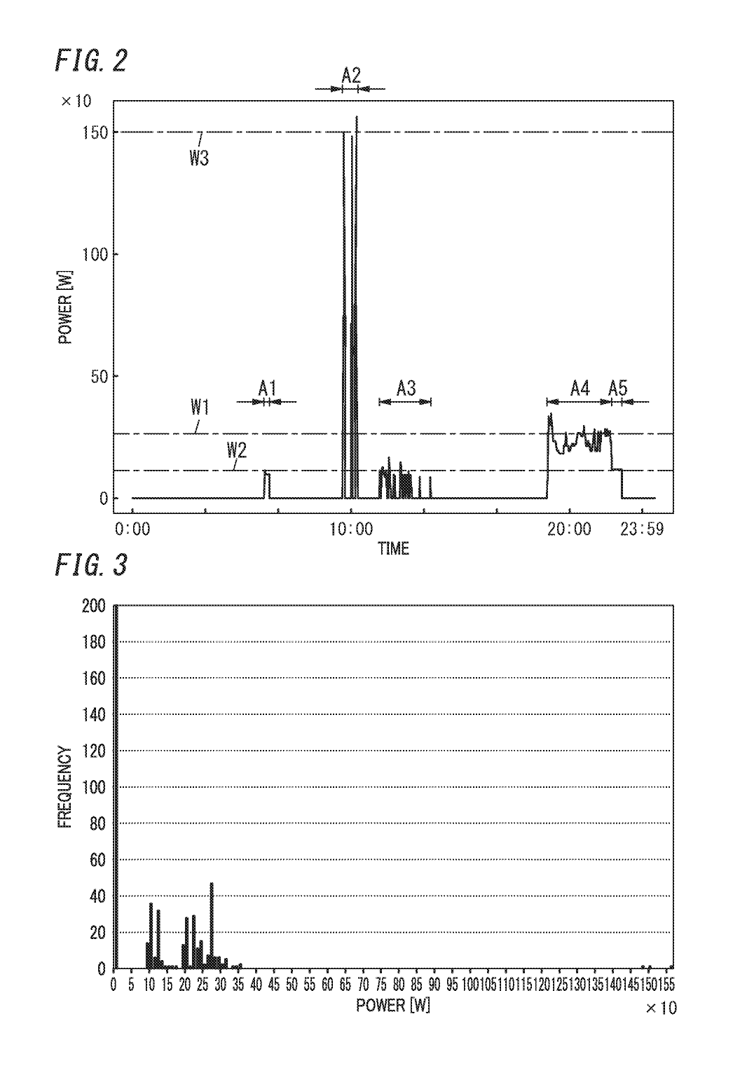

Now, description will be given on the assumption that the power value of one branch circuit 32 during the comparison period stored in the first storage unit 12 transitions as illustrated in FIG. 2 (the time period from the left end to the right end of FIG. 2 corresponds to a comparison period). In the figure, the unit time in which the power value is acquired is one minute, and the comparison period is one day. The unit of the ordinate in FIG. 2 is 10 [W]. Thus, values illustrated in the figure are values 1/10 of measured values.

FIG. 2 enables visual recognition that the comparison period includes five time periods (time periods A1 to A5 in FIG. 2) during each of which the power value remains substantially constant. During three (time periods A1, A3, and A5) of the five time periods, the power values are substantially equal to each other except for time periods having power values of 0 [W]. That is, in FIG. 2, the number of groups whose power values differ from each other is three. Based on an assumption that each time period during which the power value except for 0 [W] remains substantially constant can be associated with any electric appliance 20, the present embodiment estimates power usage based on the transition of the power value during the comparison period. In the example shown in FIG. 2, the number of groups having different power values is three, and therefore, it is estimated that the number of types of electric appliances 20 supplied with power from the branch circuit 32 is highly possibly three. In the following description, a plurality of groups is assumed to be associated with a plurality of electric appliances 20 on a one-to-one basis.

Here, standby power may also be generated during a time period during which the electric appliance 20 is not substantially operating, but the standby power is deemed to be 0 [W] to simplify the description. That is, in the following description, when the standby power is generated during the time period during which the electric appliance 20 connected to the branch circuit 32 is not operating, a state where power passing through the branch circuit 32 is 0 [W] is deemed to be a state where the power passing through the branch circuit 32 is less than or equal to the standby power. In sum, a state where power required to operate the electric appliance 20 for its intended purpose is not passing through the branch circuit 32 is denoted by 0 [W].

When the power value transitions as illustrated in FIG. 2, the analysis unit 13 has to extract three groups. To recognize the groups by the analysis unit 13, a condition that the variable width of the power value (except for 0 [W]) within each group is relatively small is used.

A time period during which power values W(t) belonging to one group are continuously generated is deemed to be a time period during which one electric appliance 20 corresponding to the group is continuously used. Here, the time period during which the power values W(t) other than 0 [W] are continuously generated may be not only the time period during which the power values W(t) are continuously generated but also a time period during which the power values W(t) are intermittently generated. When the power values W(t) belonging to one group are intermittently generated, the time interval based on which the analysis unit 13 determines that the electric appliance 20 is continuously used is limited to relatively short determination period (for example, shorter than or equal to 30 minutes).

For example, when the electric appliance 20 is an air conditioning apparatus (a so-called air conditioner), the electric appliance 20 may be configured to stop its operation once the room temperature reaches a set temperature, and in this case, there is a time period during which the power values W(t) temporarily reach 0 [W] during the operation of the electric appliance 20. This time period is about 30 seconds to about 10 minutes depending on external conditions. Also when the electric appliance 20 is an iron, an oven toaster, an electric carpet, an electric pot, or the like, the electric appliance 20 may operate in a manner as described above. Therefore, when the power values W(t) at almost the same level are intermittently generated, it has to be determined that the identical electric appliance 20 continuously operates even when there is a time period during which the power values W(t) reach 0 [W].

The analysis unit 13 recognizes one group based on the power values W(t), and additionally, when the power values W(t) belonging to the same group are intermittent, the analysis unit 13 incorporates an interval between times at which the power values W(t) are generated into the condition. In other words, the analysis unit 13 defines groups for the power values W(t) using the magnitude of changes in power value W(t) as the condition, and within each group, using a time period during which the power values W(t) are generated as a condition, the analysis unit 13 defines a period during which the electric appliance 20 is operating. In the following description, a set of power values W(t) corresponding to a time period during which the electric appliance 20 continuously operates is referred to as a subgroup. That is, the group includes one or more subgroups.

That is, since the group can be determined to correspond to one electric appliance 20, using an identical electric appliance 20 a plurality of times during the comparison period results in generation of a plurality of subgroups. For example, when the electric appliance 20 is a microwave oven, the electric appliance 20 is probably used for preparation of breakfast and for preparation of dinner. As in this case, an identical electric appliance 20 may operate two or more times in one day. As a result, a time period during which an electric appliance 20 in one branch circuit 32 is operating occurs a plurality of times, which results in a plurality of subgroups in a group.

In the example illustrated in FIG. 2, three time periods (time periods A1, A3, A5) during which the power is about 100 [W] are visually found, one time period (time period A4) during which the power is about 300 [W] is visually found, and further, one time period (time period A2) during which the power is about 1500 [W] is visually found. The time periods during which the power is about 100 [W] are about 6:00, about 11:00 to 13:30, and about 23:00 to 23:30, the time period during which the power is about 300 [W] is about 19:00 to 23:00, and the time period during which the power is about 1500 [W] is about 10:00. When the power value W(t) transitions as illustrated in FIG. 2, the analysis unit 13 has to extract three groups about 100 [W], 300 [W], and 1500 [W]. The analysis unit 13 also has to extract three subgroups for the group about 100 [W].

In order to extract the groups, the analysis unit 13 defines a reference value Wi (where i is a positive integer) as a power value which will be a representative value of each group. The reference value Wi is defined for each group, and since the example illustrated in FIG. 2 has three groups, three reference values W1, W2, and W3 are defined.

In the present embodiment, the reference value Wi is obtained based on the occurrence frequency of the power values W(t) during the comparison period. In order to define the reference value Wi, the statistical processor 131 included in the analysis unit 13 obtains the frequency distribution of the power values W(t) during the comparison period. That is, the statistical processor 131 divides the power values W(t) during the comparison period into sections of 10 [W], and obtains the frequency of the appearance of the power values W(t) of the sections.

In the present embodiment, each section is named after the lower limit value of power values included in the section. For example, the name of a section greater than or equal to 270 [W] and less than 280 [W] is 270 [W]. The width of the section dividing the power values W(t) is not limited to 10 [W] but may be another value such as 5 [W], 15 [W], or 20 [W].

The statistical processor 131 obtains the frequency distribution of the power values W(t) during the comparison period, and based on the frequency distribution, the reference value setting unit 132 included in the analysis unit 13 defines a most frequent value (the name of a section in which the frequency is maximum) as the reference value W1 of one group. FIG. 3 shows the frequency distribution of the example of FIG. 2. In FIG. 3, the abscissa shows the sections of the power values W(t), and the unit of the abscissa is 10 [W]. In this example, the name of a section corresponding to the most frequent value is 270 [W], and therefore, the reference value W1 is defined as 270 [W].

When one reference value W1 is defined, the division processor 133 uses the reference value W1 to extract a power value W(t) close to the reference value W1 from the power values W(t) during the comparison period and defines a first group to include the extracted power value W(t). The range of the power value W(t) close to the reference value W1 is defined as, for example, “a reference value W1±k*W1”, where k may be set to about 0.1 to 0.3. Note that the range of the power value W(t) close to the reference value W1 may be defined by using, for example, a fixed value but not a ratio with respect to the reference value W1.

The division processor 133 obtains a time period during which the power value W(t) close to the reference value W1 is continuously generated. If the group is dividable into subgroups, the division processor 133 obtains the subgroups. The group may include a time period during which the power is 0 [W], but when an interval between times at which power values W(t) having almost the same level are generated is shorter than or equal to the above-described determination period, the division processor 133 deems the electric appliance 20 to be being continuously used. By contrast, when the interval between the times at which the power values W(t) having almost the same level are generated is longer than the determination period, the division processor 113 treats the power values W(t) as different subgroups.

When the division processor 133 cannot divide the group into subgroups, the division processor 133 obtains a time of the appearance and a time of the disappearance of the group, whereas when the division processor 133 can divide the group into subgroups, the division processor 133 obtains a time of the appearance and a time of the disappearance of each subgroup. In sum, the division processor 133 defines a time period during which the group appears or time periods during which subgroups appear.

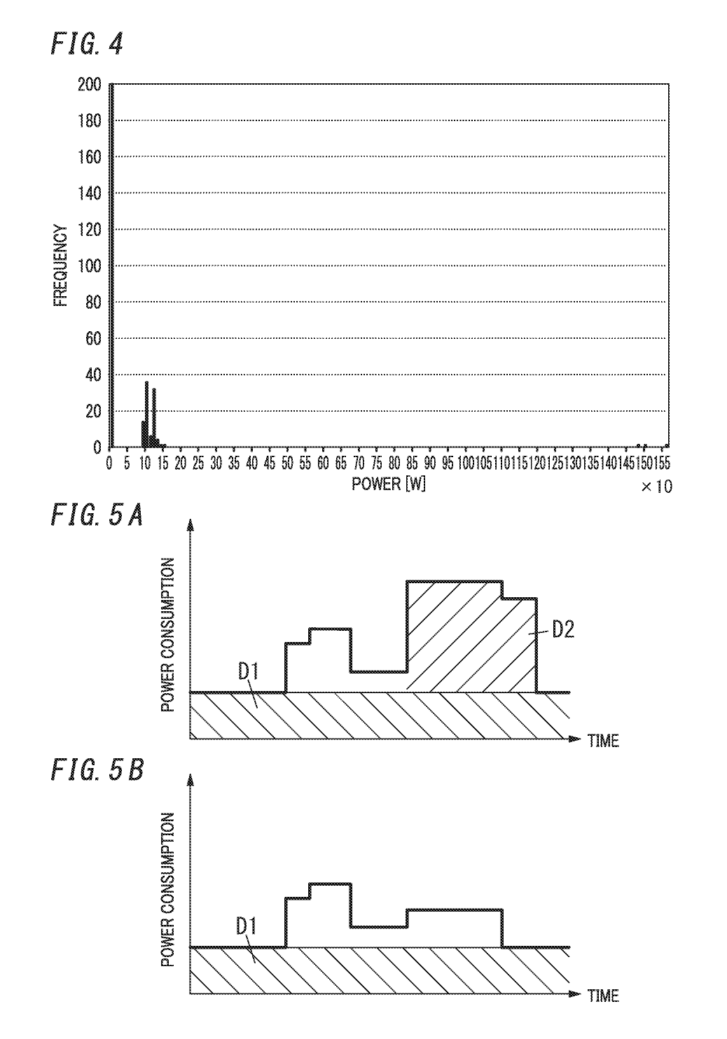

After extracting the first group, the division processor 133 extracts a power value(s) W(t) included in the time period during which the first group appears, and excludes a section including the power value W(t) from the frequency distribution obtained by the statistical processor 131. In the example illustrated in the figure, as illustrated in FIG. 4, sections of 160 [W], 170 [W], and 190 [W] to 350 [W] are excluded. The statistical processor 131 obtains frequency distribution excluding the power value W(t) belonging to the first group obtained by the division processor 133, and the reference value setting unit 132 defines the most frequent value in the frequency distribution as a second reference value W2. In FIG. 4, since the name of the section corresponding to the most frequent value is 100 [W], the reference value W2 is defined as 100 [W].

When the reference value W2 is defined, the division processor 133 obtains a group corresponding to the reference value W2 and obtains a time of the appearance and a time of the disappearance of the group. When the division processor 133 can divide the group into subgroups, the division processor 133 further obtains a time of the appearance and a time of the disappearance of each subgroup. The analysis unit 13 repeats the above-described processes to extract one group from power values W(t) during the comparison period. The analysis unit 13 repeats the above-described process until a group can no longer be extracted from the power values W(t) during the comparison period.

After excluding a power value W(t) included in one group, if a plurality of sections have equal frequencies in the frequency distribution and the frequencies of the sections are higher than frequencies of other sections, whether or not the sections having the equal frequencies are divided into groups is determined based on the number of continuous sections having a frequency of 0. For example, when equal to or more than 10 sections (100 [W]) having a frequency of 0 continue in a frequency distribution, the division processor 133 determines that two sections which are separated by the sections having a frequency of 0 and in which power values W(t) are generated belong to two different groups.

After grouping the sections, the division processor 133 determines whether or not the most frequent value of each group can be uniquely defined. When the most frequent value can be uniquely determined, the division processor 133 defines the name of a section corresponding to the most frequent value as a reference value. On the other hand, when the most frequent value of the divided group cannot be uniquely defined, the division processor 133 defines the name of a section corresponding to the most frequent value which is closest to the median value in the group as a reference value. In the example illustrated in FIG. 2, W1=270 [W], W2=100 [W], and W3=1500 [W], and a group obtained based on the reference value W2 is divided into three subgroups.

In sum, after extraction of one group, the analysis unit 13 excludes the power value W(t) included in the group and performs processing to further extract a group from the remaining power values W(t). In other words, the division processor 133 performs group extraction processing by recursively executing extraction of a group from power values W(t) during the comparison period, exclusion the power values W(t) of the extracted group, and extraction of a remaining group.

In the operation described above, the analysis unit 13 performs processing in which distances from the reference values W1 to W3 are evaluated to obtain groups, and time periods during which power values W(t) are generated are evaluated for each group to obtain a time period during which the electric appliance 20 operates.

For example, when the distance between a selected reference value (e.g., the reference value W1 of the reference values W1 to W3) and each of the power values W(t) is less than or equal to a predetermined threshold, the analysis unit 13 determines that the power value W(t) belongs to a group corresponding to the reference value W1. When the absolute value of a difference is used as the distance, the analysis unit 13 obtains, for example, |W(t)−W1| as the distance, and when the distance is less than or equal to the threshold, the analysis unit 13 determines that the corresponding power value W(t) belongs to a group corresponding to the reference value W1.

Moreover, the analysis unit 13 evaluates a time difference between times of the appearance of adjacent ones of power values W(t) belonging to a group, and when the time difference falls within a determination period, the analysis unit 13 determines that the electric appliance 20 is continuously operating. For example, in one group, a time difference (t2−t1) between a power value W(t1) generated at time t1 and a power value W(t2) generated at time t2(>t1) is obtained. When the time difference (t2−t1) falls within the determination period described above, the analysis unit 13 determines that the power value W(t1) and the power value W(t2) are generated within a time period during which the electric appliance 20 is continuously operating.

In the above operation example, when a group includes a plurality of subgroups, the subgroups are evaluated after defining the group. However, when processing described below is performed, a power value W(t) belonging to each subgroup is first defined, and then, the group is defined based on the relationship between the power value W(t) and each of the reference values W1 to W3.

That is, the analysis unit 13 evaluates each of power values W(t) during the comparison period by Math. 1 in a generation order, and when the relationship shown by Math. 1 is satisfied, the analysis unit 13 determines that the power value W(t) belongs to the same subgroup as a power value (t−1).

|W(tj)−Wi|≦Wd

and

|tj−t(j−1)|≦Td [Math. 1]

In Math. 1, j is a positive integer representing an order, Wd is the threshold relating to the distance of the power value, and Td is the determination period. Also when Math. 1 is used as a condition, the reference value Wi is defined in a similar manner to the above-described operation example. Here, a case where the reference value W1 is used as the reference value Wi is described as an example.

When a group is defined using Math. 1 as a condition, the analysis unit 13 uses, as a first condition, that the distance between each of power values W(tj) generated during the comparison period and the reference value W1 is less than or equal to the threshold Wd. When the first condition is satisfied, it means that the power value W(tj) generated at a time tj probably belongs to a group corresponding to the reference value W1. In Math. 1, the distance of the power value is the absolute value of the difference between the power value W(tj) and the reference value W1.

Next, a second condition is used to evaluate whether or not an electric appliance 20 corresponding to the power value W(tj) is continuously operating. For the power values W(tj) and W(t(j−1)) satisfying the first condition, the analysis unit 13 uses, as the second condition, that the time difference between the time tj at which the power value W(tj) is generated and the time t(j−1) at which the immediately preceding power value W(t(j−1)) is generated falls within a determination period Td. In Math. 1, the time difference is the absolute value of the difference between the time tj and the time t(j−1).

When the power value W(tj) satisfying the first condition satisfies the second condition, the division processor 133 determines that the power value W(tj) forms the same subgroup as the power value W(t(j−1)) generated at the time t(j−1). As described above, for each of the power values W(t) during the comparison period, the distance with respect to the reference value Wi and the time difference with regard to the time at which the power value W(t) is generated are evaluated, thereby it is determined whether or not subgroups are formed. Moreover, the time of the appearance of each subgroup is a time at which a power value W(t) first satisfying the condition of Math. 1 is generated. The time of the disappearance of each subgroup is a time at which the power value W(t) forming the subgroup no longer satisfies the condition of Math. 1.

The threshold Wd can be commonly set for all the branch circuits 32, and the determination period Td can be commonly set for all the branch circuits 32. However, different branch circuits 32 generally connected to different electric appliances 20. Thus, the threshold Wd is preferably settable for each of the branch circuits 32, and the determination period Td is preferably settable for each of the branch circuits 32.

For a power value W(t) of the time of appearance of a subgroup, there is no immediately preceding power value W(t(j−1)) in this subgroup, and therefore, the analysis unit 13 uses only the first condition of Math. 1 until a first power value W(tj) of the subgroup is detected. After the detection of the power value W(tj) satisfying the first condition, the analysis unit 13 extracts the subgroup using both the first condition and the second condition.

When the comparison period includes only one subgroup, the subgroup is equivalent to a group. When the comparison period includes a plurality of subgroups, the subgroups may form one group. Therefore, when a plurality of subgroups obtained by evaluating the first condition and the second condition with the same reference value Wi during the comparison period are extracted, the analysis unit 13 treats these subgroups as one group.

At least one of the threshold Wd and the determination period Td is preferably settable for each branch circuit 32. When the threshold Wd is set to a small value, a resolution with respect to the power value W(t) increases, and adjusting the determination period Td enables highly accurate determination of whether or not the electric appliance 20 is continuously operating according to characteristics of the operation of the electric appliance 20 connected to the branch circuit 32.

For example, in a case where the threshold Wd is set to 50 [W], when the reference value is Wi, a power value W(t) satisfying the relationship Wi−50 [W]≦W(t)≦Wi+50 [W] is treated as a candidate of a group. That is, the group can be divided by the unit of 100 [W]. Similarly, when the threshold Wd is 100 [W], the group can be divided by the unit of 200 [W].

Therefore, adjustment of the threshold Wd is possible, that is, the threshold Wd may be set to a relatively small value for the branch circuit 32 of a living room in which a plurality of electric appliances 20 may be connected to the branch circuit 32, and the threshold Wd may be set to a relatively large value for the branch circuit 32 in a kitchen in which a small number of electric appliances 20 are connected to the branch circuit 32.

When the determination period Td is set to be relatively long for an electric appliance 20 such as a toaster or an iron which is repeatedly turned on/off during its operation, the operation of the electric appliance 20 can be determined to be continues even when the electric appliance 20 is repeatedly turned on/off. When the determination period Td is set to be relatively short for an electric appliance 20 such as a television set (television receiver) or a lighting apparatus whose power value W(t) during operation does not significantly vary, the types of the electric appliance 20 can be easily determined.

The conditions shown by Math. 1 are mere examples, and as a condition for extracting a group or a subgroup, other conditions may be used, and as described above, for example, a condition may be set such that a group is obtained, and then the group is divided into subgroups.

The analysis unit 13 extracts groups or subgroups based on the power values W(t) stored in the first storage unit 12, and further defines times of the appearance and the disappearance of each group or each subgroup. In the present embodiment, each of the groups is assumed to correspond to the electric appliance 20, and the electric appliance 20 is assumed to be in an operating state from a time of the appearance of the subgroup (the group when the number of the subgroup is one) to a time of the disappearance of the subgroup. The analysis unit 13 defines a group, and then obtains a power value of the group. The power value is hereinafter referred to as a “consumed power value.”

The consumed power value is a power value while the electric appliance 20 is operating and may thus vary over time. Therefore, the consumed power value is expressed by using either a representative value of a variable range or the variable range. The representative value of the variable range may be, for example, an average value of the maximum value and the minimum value of the power values in the group, a median value of the power values in the group, an average value of the power values in the group, or a reference value defining the group. In a case where a power value other than the reference value is to be used as the consumed power value, if a power value of 0 [W] is included in the group, the analysis unit 13 uses power values obtained after excluding the power value of 0 [W] from power values included in a group so as to obtain the consumed power value. In a case where the variable range is to be used, for example, any upper limit and lower limit can be used as long as the maximum value, the minimum value, and the representative value of the power value in the group are included in the variable range between the upper limit and the lower limit.

As can be seen from the above description, for each branch circuit 32, the analysis unit 13 extracts groups in each of which a corresponding electric appliance 20 is deemed to be operating from a plurality of pieces of power information stored in the first storage unit 12, obtains a time at which the electric appliance 20 started its operation and a time at which the electric appliance 20 stopped its operation for each group, and further obtains a consumed power value. Groups into which the pieces of power information are classified by the analysis unit 13 are temporarily stored in the second storage unit 15 together with the consumed power values, the time of the appearance and the time of the disappearance of each group, and other information. When numbers are added to the pieces of power information by the first storage unit 12, the second storage unit 15 may store pieces of data to which the groups are associated according to the numbers. The second storage unit 15 stores pieces of information obtained by classifying the pieces of power information during the comparison period into groups.

The estimation unit 14 uses the pieces of information stored in the second storage unit 15 to estimate power usage of each branch circuit 32 and stores the estimated power usage in the second storage unit 15. In the present embodiment, the comparison period is one day, and the analysis unit 13 obtains the consumed power value of each group in each day. Here, in many cases, a different comparison period (i.e., a different day) results in a different time period of the operation of the electric appliance 20 corresponding to the group. That is, a time zone in which an identical electric appliance 20 is operating varies depending on the day. However, even when comparison periods are different from each other, no significant variation in consumed power value of each branch circuit 32 is expected on days having identical attributes. Therefore, even when the comparison periods are different from each other and time periods during which power values are continuous are different from each other, if the consumed power values of one branch circuit 32 are almost at the same level on days having identical attributes, the analysis unit 13 deems the power values to be the same group.

To determine whether the power values are the same group, the analysis unit 13 may use a time period from the appearance to the disappearance of a power value of a group together with the consumed power value. That is, the analysis unit 13 may use a time period from the appearance to the disappearance of a power value of a group, wherein when the difference between such time periods of two groups is within an allowable range, the analysis unit 13 may determine that the two groups correspond to an identical electric appliance 20.

The transition of the power value of each branch circuit 32 is expected to differ depending on attributes of the day. For example, when the electric appliance 20 is an indoor lighting apparatus, the lighting-on time of the electric appliance 20 is different between the summer season and the winter season, and when the electric appliance 20 is an outdoor lighting apparatus (e.g., a gate lamp), the lighting-on time and the lighting-off time of the electric appliance 20 are different between the summer season and the winter season. Moreover, a time zone in which the electric appliance 20 is used is highly probably different between weekdays and holidays. For example, a time zone in which a cooking apparatus is used is expected to be different between weekdays and holidays. Note that the present embodiment has a precondition that the lifestyle of residents does not significantly vary. The technique of the present embodiment is not expected to be applied to a very irregular lifestyle.

The attributes of the day of the present embodiment mean attributes significantly influencing the transition of the power value. Therefore, examples of the attributes of the day include outdoor temperatures, weather, and other parameters in addition to calendrical attributes such as the day of the week (difference between weekdays and holidays), months, and seasons. Taking all of these attributes of the day into consideration increases the accuracy of estimation relating to the power usage by the estimation unit 14, but in general, it suffices to take one or two types of the attributes into consideration. The estimation unit 14 compares pieces of power information of groups on days having different attributes as described below to estimate the power usage of the branch circuit 32.

As an example, FIGS. 5A and 5B show a transition of the power value of a branch circuit 32 corresponding to a living room. Here, the attributes of days are assumed to be the winter season and the fall season. FIG. 5A shows a transition of a power value in one day in the winter season, and FIG. 5B shows a transition of a power value in one day in the fall season. FIGS. 5A and 5B include time periods during which a plurality of electric appliances 20 is simultaneously used.

Comparison between FIGS. 5A and 5B shows that none of FIGS. 5A and 5B includes a time period during which the power value reaches 0 [W], and that a time period occurs during which the power value on the last half of the day more significantly increases in the winter season than in the fall season. That is, FIG. 5A includes an area D1 showing that the power value is substantially constantly consumed through one day and an area D2 which appears in the winter season. Therefore, the pieces of power information of the groups in days having different attributes are compared with each other, thereby estimating that an electric appliance 20 which is not used in the fall season is used in the winter season.

The power values that transition as shown in FIG. 5A are assumed to be classified into four groups, and the power values that transition as shown in FIG. 5B are assumed to be classified into three groups. After the classification into the groups, a time period from the appearance to the disappearance of each group and the above-described consumed power value are obtained, and therefore, the time period is deemed to be a time period during which the electric appliance 20 is operating, and the consumed power value is multiplied by the time period from the appearance to the disappearance of each group, thereby obtaining consumed energy of each group. This calculation is performed by a calculation unit 17 included in the power usage estimation device 10. The consumed energy is obtained with a high accuracy by integrating the power values during the time period during which the electric appliance 20 is operating, but since the consumed power value representing the group is known, the consumed energy may be simply obtained based on a product of the time period and the consumed power value.

For example, from the transition of the power value shown in FIG. 5A, the group and the consumed energy as illustrated in Table 1 are assumed to be obtained. From the transition of the power value shown in FIG. 5B, the groups and the consumed energy are assumed to be obtained as illustrated in Table 2. Comparison between Table 1 and Table 2 shows that a group having a consumed power value of 500 [W] occurs in the winter season.

TABLE 1

| Group [W] | Name | Consumed Energy [Wh] |
|---|---|---|
| 100 | G1 | 1800 |
| 200 | G2 | 1500 |
| 300 | G3 | 100 |
| 500 | G4 | 3000 |

TABLE 2

| Group [W] | Name | Consumed Energy [Wh] |
|---|---|---|
| 100 | G1 | 1900 |
| 200 | G2 | 1800 |
| 300 | G3 | 200 |

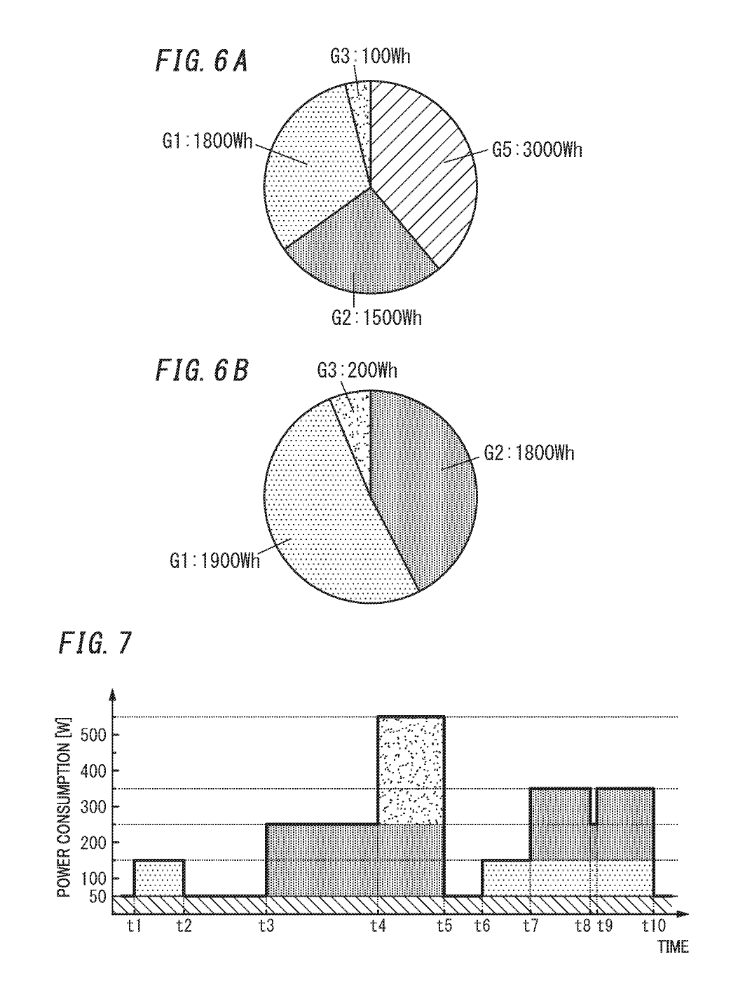

Note that the item “Name” in each of Table 1 and Table 2 is a provisional name to distinguish groups, and names G1 to G4 in the item “Name” correspond to symbols G1 to G4 shown in FIGS. 6A and 6B. However, the item “Name” is not essential. The groups into which the transmission is classified by the analysis unit 13 and the consumed power values obtained by the estimation unit 14 can be displayed in table form as illustrated in Table 1 and Table 2 on a display 50. Alternatively, the groups and the consumed power values may be displayed in pie chart form as illustrated in FIGS. 6A and 6B on the display 50. The power usage estimation device 10 includes an output unit 18 configured to output information to the display 50.

In the examples shown in the figures, the consumed energy of each group is shown, but since times of the appearance and the disappearance of the group and the consumed power value of the group are known, obtaining information about a unit price of an electricity tariff of each of time zones in which power is consumed enables calculation of the electricity tariff. That is, the calculation unit 17 obtains the electricity tariff of each group from the unit price of the electricity tariff and the power information of each group. The electricity tariff obtained by the calculation unit 17 is displayed together with the consumed energy on the display 50. The consumed energy and the electricity tariff can be obtained using the comparison period as a unit, and therefore, the calculation unit 17 is capable of obtaining, for example, consumed energy and an electricity tariff of one day. The calculation unit 17 is also capable of obtaining consumed energy and an electricity tariff per month in order to obtain a rough value of the amount of payment.

The above-described operation clearly shows that classification into groups based on the pieces of power information provides a time period during which the electric appliance 20 corresponding to the group is operating and/or a consumed power value representing the group as a feature amount of the group. A stationary range of the feature amount is defined based on feature amounts obtained on a plurality of days having identical attributes. For example, when 15 days sectioned according to the solar term are deemed to be a plurality of days having identical attributes (weekdays and holidays are preferably distinguished), the stationary range of the feature amount of the group can be defined by using a feature amount obtained on each day. The stationary range is set within a range of, for example, (average value±α×standard deviation). The factor α is set to about 1 to 3.

The estimation unit 14 defines the stationary range for the feature amount of the group in the above-described manner, and compares a feature amount extracted from power information of each day with the stationary range.

When the feature amount extracted from the power information of each day exceeds the upper limit of the stationary range, the estimation unit 14 determines that power consumed by the branch circuit 32 is greater than power consumed in the stationary state, and estimates that the power may be consumed wastefully. For example, when the feature amount indicates the operation time period of the electric appliance 20, power may be wasted by forgetting to turn off the electric appliance 20. Alternatively, when the feature amount indicates the consumed power value of an air conditioning apparatus as the electric appliance 20, it is estimated that the set temperature of the air conditioning apparatus was changed. In case of a group in which the feature amount does not vary through the comparison period, it is estimated that an electric appliance 20 such as a refrigerator which stationarily operates is connected to the branch circuit 32.

When a plurality of electric appliances 20 is connected to one branch circuit 32, these electric appliances 20 may operate in the same time zone. Such an event will be described below.

Here, as an example, it is assumed that for a branch circuit 32 corresponding to a “living” room, the power values included in the pieces of power information stored in the first storage unit 12 transition as shown in FIG. 7. Moreover, it is assumed that estimation of the electric appliance 20 is performed on a holiday in the winter season. FIG. 7 schematically shows the power information, and the consumed power value of each group is shown by using one value instead of using two values, the maximum value and the minimum value.

In the example shown in FIG. 7, the power value from time t1 to time t2 is 150 [W], the power value from time t3 to time t4 is 250 [W], and the power value from time t4 to time t5 is 550 [W]. The power value from time t6 to time t7 is 150 [W], each of the power value from time t7 to time t8 and the power value from time t9 to time t10 is 350 [W], and the power value from time t8 to time t9 is 250 [W]. Each of the power value from the time t2 to the time t3 and the power value from the time t5 to the time t6 is 50 [W].

In the example shown in FIG. 7, the analysis unit 13 classifies consumed power values into five groups of 50 [W], 150 [W], 250 [W], 350 [W], and 550 [W]. Since no time period during which the power value reaches 0 [W] exists, the analysis unit 13 determines that stationarily operating electric appliances 20 are connected, and the analysis unit 13 allocates the group of 50 [W], which represents that the consumed power value is minimum, to a stationarily operating electric appliance 20.

Next, for the remaining four groups, the consumed power values of the remaining four groups are corrected to 100 [W], 200 [W], 300 [W], 500 [W] by subtracting 50 [W] from the consumed power value. When the corrected consumed power values change as an elapse of time, a duration of the consumed power value before the change and a duration of the consumed power value after the change are obtained. For example, in FIG. 7, the consumed power value changes at the time t4, and therefore, a time period (duration) from the time t3 to the time t4 and a time period (duration) from the time t4 to the time t5 are obtained. In the following description, the consumed power value after the correction will be used.

Here, the above-described determination period is defined for each of the durations, and when the durations before and after the change are both greater than or equal to the determination period, the estimation unit 14 performs estimation of the consumed power value of the electric appliance 20 as described below.

That is, when the consumed power value increases, the estimation unit 14 estimates that a new electric appliance 20 starts operating during the time period during which the electric appliance 20 corresponding to the consumed power value before the increase is operating. Therefore, a value obtained by subtracting the consumed power value after the change from the consumed power value before the change is estimated to be the consumed power value of the new electric appliance 20. In the example shown in FIG. 7, at the time t4, the consumed power value changes from 200 [W] to 500 [W], and therefore, it is estimated that an electric appliance 20 having a consumed power value of 300 [W] started operating. Similarly, at the time t7, it is estimated that an electric appliance 20 having a consumed power value of 200 [W] started operating.

The above-described example relates to a case where the consumed power value increases, but in a case where the consumed power value decreases, it is estimated that the electric appliance 20 corresponding to the consumed power value before the change stopped. That is, a value obtained by subtracting the consumed power value after the change from the consumed power value before the change is estimated to be the consumed power value of the electric appliance 20 having been operated before the change.

When the duration before the change is greater than or equal to the determination period and the duration after the change is shorter than the determination period, the electric appliance 20 before the change is deemed to be continuously being used. For example, in the example shown in FIG. 7, the consumed power value reaches 200 [W] at the time t8. Here, the duration of 200 [W] (time period from the time t8 to the time t9) is determined to be shorter than the determination period, and an electric appliance 20 having a consumed power value of 200 [W] and an electric appliance 20 having a consumed power value of 100 [W] are deemed to be operating continuously.

Similarly, when the duration before the change is shorter than the determination period, and the duration after the change is longer than or equal to the determination period, the consumed power value before the change is ignored, and it is determined that the electric appliance 20 after the change is operating. In the example shown in FIG. 7, the consumed power value changes from 200 [W] to 300 [W] at the time t9. Since the time period from the time t8 to the time t9 is determined to be shorter than the determination period, an electric appliance 20 having a consumed power value of 200 [W] and an electric appliance 20 having a consumed power value of 100 [W] are deemed to be operating continuously also in this case.

Results of the estimation by the estimation unit 14 are displayed via the output unit 18 included in the power usage estimation device 10 on the display 50. The display 50 may be configured dedicatedly to the power usage estimation device 10 or may be disposed separately from the power usage estimation device 10. Displaying the results of the estimation by the estimation unit 14 on the display 50 easily notifies a user of the power usage of each branch circuit 32.

Examples of the display 50 disposed separately form the power usage estimation device 10 include flat panel displays such as liquid crystal displays. The output unit 18 may be provided with an interface unit configured to communicate with a terminal apparatus, and the terminal apparatus may be used as the display 50. Examples of the terminal apparatus include personal computers, smartphones, and tablet terminals.

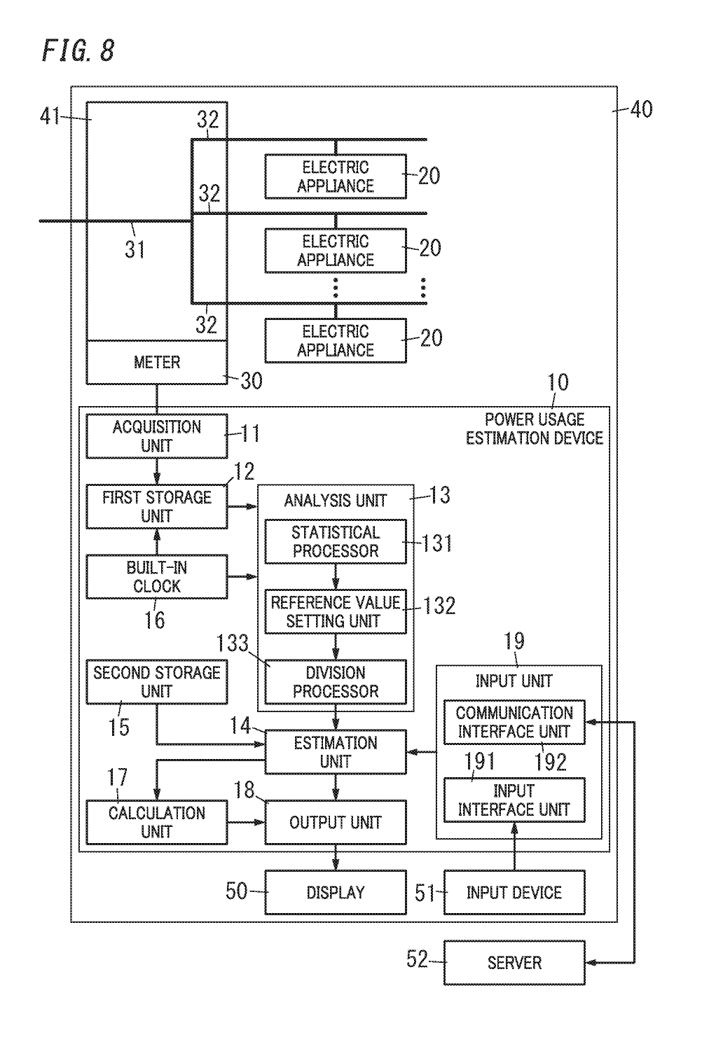

In the above-described configuration example, the pieces of power information are classified into power values of the electric appliances 20, and as Table 1 or Table 2 described above, the names of the groups are represented by the power values. When the pieces of information specifying the groups are shown in power values, a user may not be able to associate the power values to the electric appliances 20. Therefore, as illustrated in FIG. 8, the power usage estimation device 10 includes an input unit 19 to which apparatus information is input. The apparatus information is information specifying electric appliances 20 and includes names representing the types of the electric appliances 20 (hereinafter referred to as “apparatus names”).

In the configuration example shown in FIG. 8, the input unit 19 includes an input interface unit 191 (hereinafter referred to as an “input I/F unit”) and a communication interface unit 192 (hereinafter referred to as a “communication I/F unit”). Note that the communication I/F unit 192 may be omitted. The input I/F unit 191 receives information input from an input device 51. The input device 51 may also serve as the display 50. The communication I/F unit 192 is capable of communicating with a server 52 including a data base system and has a function of acquiring the apparatus names from the server 52.

The server 52 is assumed to be a server (external server) managed by a third party but may be a server (internal server) owned by a consumer. The external server communicates with the communication I/F unit 192 via an electronic communication network such as the Internet, a mobile communication network, or the like. The internal server communicates with the communication I/F unit 192 via an electronic communication network such as Local Area Network (LAN), a dedicated line, or the like.

The apparatus information including the apparatus names input via the input unit 19 is delivered to the estimation unit 14. The estimation unit 14 associates each of the apparatus names to a corresponding one of the groups and stores data associating the groups to the apparatus names in the second storage unit 15. When the data including the groups and the apparatus names associated with the groups is stored in the second storage unit 15, the output unit 18 can use the apparatus names, but not the power values representing the groups, to display information on the display 50. The output unit 18 is capable of displaying the power values representing the groups together with the apparatus names.

To enable the estimation unit 14 to associate the groups with the apparatus names, the apparatus information delivered from the input unit 19 to the estimation unit 14 includes not only the apparatus names but also information specifying the branch circuit 32 to which the electric appliances 20 are connected and information about the consumed power values according to the specifications of the electric appliances 20. That is, the apparatus information is shown in a form in Table 3.

TABLE 3

| | | Power Consumption |
|---|---|---|
| Location of Use | Apparatus Name | Value [W] |
| Living Room | Television Set | 200 |
| Living Room | Lighting Apparatus | 100 |
| Living Room | Heater | 300 |
| Living Room | Electric Carpet | 500 |
| Living Room | PC | 200 |
| Kitchen | Microwave Oven | 1000 |
| Toilet and Bathroom | Hair Blower | 1200 |
| . . . | . . . | . . . |

When the second storage unit 15 stores the apparatus information as shown in Table 3, the output unit 18 can use the apparatus names, but not the power values or provisional names, to denote the groups. Now, as illustrated in Table 1, the provisional name of a group having a power value of 100 [W] is assumed to be G1, and the provisional name of a group having a power value of 500 [W] is assumed to be G4. Moreover, the power values of the group G1 and the group G4 are obtained from the branch circuit 32 corresponding to a living room.

According to Table 3, an electric appliance 20 having a consumed power value of 100 [W] in the branch circuit 32 corresponding to the living room is a lighting apparatus, and an electric appliance 20 having a consumed power value of 500 [W] in the branch circuit 32 corresponding to the living room is an electric carpet. Therefore, with reference to the apparatus information as shown in Table 3, the output unit 18 can associate the apparatus name “lighting apparatus” with the group G1 in which the consumed power value is 100 [W] in the living room, and the output unit 18 can display the apparatus name on the display 50. Similarly, the output unit 18 can associate the apparatus name “electric carpet” with the group G4 in which the consumed power value is 500 [W] in the living room, and the output unit 18 can display the apparatus name on the display 50.

In this way, the power values or provisional names of the groups are not displayed on the display 50 but the apparatus names corresponding to the groups are displayed on the display 50, which enables a user to easily understand the information. The apparatus information shown in Table 3 not only associates the apparatus names with the consumed power values but also associates the “location of use” with the branch circuit 32. Therefore, the output unit 18 can express the branch circuit 32 from which the group is extracted by using the name in the item “location of use.” That is, the electric appliance 20 can be displayed on the display 50 by its apparatus name, and the branch circuit 32 can be displayed on the display 50 by its location of use.

In Table 3, two types of electric appliances 20, “television set” and “PC” correspond to a group having a consumed power value of 200 [W] in the branch circuit 32 corresponding to the living room. Here, PC means a personal computer. As in this case, when a plurality of electric appliances 20 having substantially the same consumed power values exist in a single branch circuit 32, the apparatus names of the electric appliances 20 cannot be automatically associated with the consumed power values.

Therefore, when a plurality of electric appliances 20 having substantially the same consumed power values exists, the output unit 18 displays the apparatus names of these electric appliances 20 as selection items on the display 50, and preferably promotes a user to select an apparatus name from the selection items. That is, when the output unit 18 displays the apparatus names of the plurality of electric appliances 20 as selection items on the display 50, the output unit 18 also displays indication to enable a user to select an apparatus name. In a state where the indication of selection is displayed on the display 50, a user can select an apparatus name by using the input device 51.

In the above-described example, the display 50 displays “television set” and “PC” as the apparatus names of the electric appliances 20. A user associates the group with the television set or the PC by using the input device 51. However, in practice, one day may include a time zone in which the television set is operated and a time zone in which the PC is operated, and therefore, an apparatus name is preferably associated with each subgroup. When an apparatus name is associated with each subgroup, the apparatus name is given per time zone.

The above described processing is performed by using the information in Table 1 and Table 3, thereby associating the groups and the apparatus names with each other as illustrated in Table 4 for the branch circuit 32 corresponding to the living room. Here, the group G1 corresponds to the lighting apparatus, the group G2 corresponds to the television set, the group G3 corresponds to a heater, and the group G4 corresponds to the electric carpet.

TABLE 4

| Group [W] | Apparatus Name | Consumed Energy [Wh] |
|---|---|---|
| 100 | Lighting Apparatus | 1800 |
| 200 | Television Set | 1500 |
| 300 | Heater | 100 |
| 500 | Electric Carpet | 3000 |

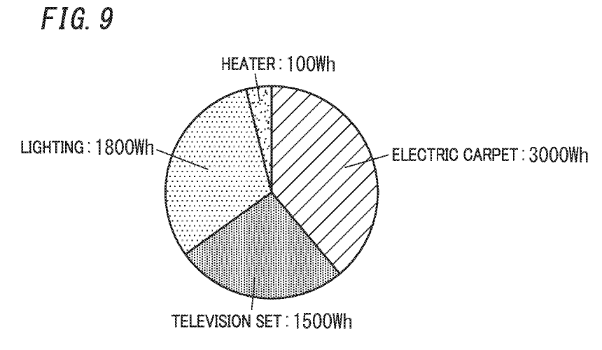

To display the consumed energy in pie chart form on the display 50 as shown in FIG. 6A, the information shown in Table 4 is used, thereby enabling the consumed energy to be displayed on the display 50 as shown in FIG. 9 with the specific apparatus name, but not the provisional names of the groups. When the consumed energy of a specific branch circuit 32 is displayed in pie chart form on the display 50 with the specific apparatus names, a user can intuitively recognize the relationship of the consumed energy and the electric appliances 20 in the specific branch circuit 32.

In the above-described processing, the apparatus information is input from the input device 51, and therefore, the communication I/F unit 192 may be omitted. The apparatus information includes the apparatus names of the electric appliance 20, information specifying the branch circuit 32 to which the electric appliances 20 are connected, and information about the consumed power values according to the specifications of the electric appliances 20. It can be said that a user knows the apparatus names and the information about the branch circuit 32, but in general, the user does not know the information about the consumed power values according to the specifications of the electric appliance 20.

The model number of an electric appliance 20 (i.e., a symbol identifying the type of the electric appliance 20) is generally shown on the electric appliance 20. Therefore, a user can know the model number by viewing the electric appliance 20. Thus, when the apparatus information is input from the input device 51, the information about the model number may be input instead of the consumed power value according to the specification of the electric appliance 20. When the information about the model number is input via the input I/F unit 191, the estimation unit 14 performs communication via the communication I/F unit 192 with the server 52.

The server 52 includes a data base system storing data including the specifications of the electric appliances 20 and the model numbers associated with the specifications. The server 52 has a function of extracting a consumed power value according to the specification of the electric appliance 20 upon receiving a request specifying the model number from the communication I/F unit 192 to return the consumed power value according to the specification to the communication I/F unit 192. The server 52 includes a storage unit storing data in the form of a data table shown in Table 5.

TABLE 5

| | Model | Power Consumption |
|---|---|---|
| Apparatus Name | Number | Value [W] |
| Television Set | AAA | 200 |
| Lighting Apparatus | BBB | 100 |
| Heater | CCC | 300 |
| Electric Carpet | DDD | 500 |
| Microwave Oven | EEE | 1000 |
| Hair Blower | FFF | 1200 |
| . . . | . . . | . . . |

The data as illustrated in Table 5 enables extraction of the consumed power value according to the specification upon receiving the model number or a request specifying the model number and the apparatus name. The server 52 may be an external server or an internal server. When the server 52 stores data as shown in Table 5, a user inputs the model number instead of the consumed power value according to the specification of the electric appliance 20 in inputting the apparatus information from the input device 51. The server 52 receives via the communication I/F unit 192 information about the model number input to the input device 51 and checks with the storage unit to extract the consumed power value according to the specification. After the consumed power value is extracted from storage unit, the server 52 returns the consumed power value to the communication I/F unit 192.

The consumed power value returned the communication I/F unit 192 is delivered to the estimation unit 14 together with other apparatus information and is used for a process of associating the apparatus name to the group. That is, even if a user does not know the consumed power value according to the specification of the electric appliance 20, simply checking the model number of the electric appliance 20 and inputting the model number to the input device 51 enables the estimation unit 14 to associate the apparatus name with the group.

The data shown in Table 5 is stored with the model numbers, the apparatus names, and the consumed power values of the electric appliances 20 being associated to each other, and therefore, not only the model numbers but also the apparatus names may be input to the input device 51. In many cases, the model number is a sequence of characters expressing no meaning, and therefore, a user may erroneously input the model number. However, inputting the model number together with the apparatus name increases the possibility of detecting an input error. That is, the server 52 is preferably configured to return the consumed power value to the communication I/F unit 192 when a combination of the model number and the apparatus name matches with the data shown in Table 5.

When the apparatus name input from the input device 51 matches with the data but the model number does not match with the data, the server 52 returns information showing that the input is erroneous to the communication I/F unit 192, and the server 52 causes the display 50 to display the information. Thus, when the display 50 points out an input error, reentering a combination of the model number and the apparatus name to the input device 51 is allowed.

A configuration may be used in which a touch panel serving as the input device 51 is superimposed on the screen of the display 50, and the display 50 also serves as the input device 51. In this case, a configuration may be used in which the display 50 displays a plurality of types of apparatus names as selection items, and a user touches an area in which a desired selection item is displayed with a finger, or the like, thereby selecting the apparatus name from the plurality of types of selection items. As long as the apparatus name is input as the apparatus information from the input device 51, this configuration is also applicable to a case where no model number is input.

Since the model number is given to each type of products, a plurality of electric appliances 20 having the same model number may be used in a building. For example, when the electric appliance 20 is a lighting apparatus, lighting apparatuses having the same model number may be installed in different rooms. Here, an example in which groups of power values as shown in Table 6 are extracted for each of a branch circuit 32 in the living room, a branch circuit 32 in the kitchen, and a branch circuit 32 in the toilet and bathroom will be described.

TABLE 6

| Power Value [W] | Power Value [W] | Power Value [W] |
|---|---|---|
| (Living Room) | (Kitchen) | (Toilet and Bathroom) |
| 100 | 100 | 50 |
| 200 | 250 | 1200 |
| 300 | 1000 | |
| 500 | | |

In the example shown in Table 6, a group having a power value of 100 [W] exists in each of the living room and the kitchen. Even if electric appliances 20 each having a power value of 100 [W] are lighting apparatuses, and the lighting apparatuses having the same model number are disposed in the living room and the kitchen, the estimation unit 14 cannot determine to which of the living room and the kitchen the lighting apparatus having the model number is to be associated. That is, the estimation unit 14 does not recognize that the electric appliances 20 in the living room and the kitchen have the same model number, therefore, the estimation unit 14 cannot associate the group of a power value corresponding to the consumed power value extracted by the server 52 with the group of the power value of each of the living room and the kitchen.

In such a case where it is not possible to determine, only by the consumed power value extracted by the server 52 based on the model number input to the input device 51, that the group is to be associated with an electric appliance 20 of which branch circuit 32, the estimation unit 14 displays branch circuits 32 as selection items on the display 50. This state enables operation of the input device 51 to select the branch circuit 32, and the estimation unit 14 associates the selected branch circuit 32 by the input device 51 with the group of the corresponding power value.

For example, in the above-described example, the estimation unit 14 displays a command to select either the living room or the kitchen on the display 50 and accepts an input via the input device 51. Here, a user selects either the living room or the kitchen by using the input device 51, and thereby, the selected branch circuit 32 is associated with the group of the power value.

As described above, the estimation unit 14 uses the apparatus information input from the input device 51 or the apparatus information obtained by checking the model number input to the input device 51 with the server 52, thereby associating the apparatus name with the group of the power value. That is, the apparatus name representing the actual electric appliance 20 but not the provisional name is associated with the group of the power value, which enables display of information which is easy to be understood by a user.

The power usage estimation device 10 may be accommodated in a controller of a Home Energy Management System (HEMS). Alternatively, some of the functions of the power usage estimation device 10 may be realized by a server (which may be a cloud server), and the functions of the server may be used from a terminal apparatus.

The configuration example described above uses the pieces of power information stored in the first storage unit 12, which means that the estimation unit 14 estimates the power usage in the past. That is, an operation state of each electric appliance 20 corresponding to the group in the past is estimated. On the other hand, when no change is found in the electric appliance 20 connected to the branch circuit 32, the group can be estimated based on power information (power value and time), and therefore, the power usage of each group can be estimated substantially in real time. The power usage estimation device 10 of the present embodiment can be used in such applications.

The power usage estimation device 10 described above includes the acquisition unit 11, the first storage unit 12, the analysis unit 13, the estimation unit 14, and the second storage unit 15. The acquisition unit 11 acquires, from the meter 30, power values of power passed through an electric circuit (the main circuit 31 or the branch circuit 32) of a consumer facility. The first storage unit 12 stores pieces of power information each including a corresponding one of the power values acquired by the acquisition unit 11 and a day and a time which are associated with the corresponding one of the power values. The analysis unit 13 classifies one or more pieces of power information satisfying a predetermined condition, of the pieces of power information stored in the first storage unit per day, into one of groups which corresponds to the predetermined condition. The second storage unit 15 stores the groups into which the pieces of power information are classified by the analysis unit 13. The estimation unit 14 estimates power usage of the electric circuit (main circuit 31 or branch circuit 32) by comparing the one or more pieces of power information of the groups stored in the second storage unit 15 between a plurality of days having different attributes.

With this configuration, the pieces of power information (measured power values) are classified into groups, and therefore, the consumed power value of each electric appliance 20 does not have to be known in advance, and it becomes possible to simply estimate an electric appliance 20 of which amount of power consumption is connected. Information about the attributes of a day is also used together with the pieces of power information. Therefore, the name of the electric appliance 20 can be estimated from the power value and the attributes of the day as long as the electric appliance 20 is a general electric appliance. That is, when such types of information are prepared in, for example, table form, the name of the electric appliance 20 can be simply estimated.

For example, in the branch circuit 32 in the kitchen, if there is a group having a consumed power value greater than 1000 [W] and the group appears in time zones before meals, an electric appliance 20 of this group is estimated to be either a microwave oven or an Induction Heating (IH) cooking heater. Similarly, in the branch circuit 32 in the living room, if there is a group having a consumed power value between 100 [W] and 300 [W] inclusive and the group appears in a daytime on a holiday, an electric appliance 20 of this group is estimated to be a television set.

Here, for example, the analysis unit 13 determines whether or not the power value included in the power information belongs to a predetermined range including the reference value as a predetermined condition, and when the power value is determined to belong to the predetermined range, the analysis unit 13 determines that the power value satisfies the predetermined condition.

Moreover, the comparison performed by the estimation unit 14 is, for example, a comparison of power information included in a group belonging to a first day and power information included in a group belonging to a second day, the attribute of the first day being different from the attribute of the second day.

Moreover, comparison of pieces of power information of each group on a plurality of days having different attributes with each other enables estimation of power usage of an electric appliance 20 such as a cooling and heating equipment used seasonally or an electric appliance 20 such as a refrigerator used regardless of the day.

The estimation unit 14 obtains a stationary range of a feature amount extracted from transitions of the power values of each of the groups on a plurality of days having identical attributes. The estimation unit 14 may estimate the power usage of the electric circuit by comparing the obtained stationary range with the feature amount extracted on each of the days having the identical attributes.

With this configuration, when the feature amount is the power value, and the feature amount exceeds the upper limit of the stationary range, power consumption is estimated to be more than usual. When the feature amount is the duration, and the feature amount exceeds the upper limit of the stationary range, it is estimated that turning off of the electric appliance 20 is forgotten or the electric appliance 20 is wastefully used.

Here, each of the attributes of days is preferably at least one of a day of a week, a month, a season, an outdoor temperature, and weather. The day of the week, month, and season are pieces of information obtained by built-in clock 16, and therefore, a configuration for connecting a sensor or a configuration to be connected to an electronic communication network such as the Internet is not necessary. The outdoor temperature and the weather require a configuration for connecting a sensor or a configuration to be connected to an electronic communication network, but such a configuration enables more accurate acquisition of information to classify groups when the electric appliance 20 is an air conditioning apparatus or a lighting device.

The analysis unit 13 preferably includes the statistical processor 131, the reference value setting unit 132, and the division processor 133. The statistical processor 131 obtains a frequency distribution of the power values included in the pieces of power information during a predetermined comparison period stored in the first storage unit 12. The reference value setting unit 132 defines a most frequent value of the power values in the frequency distribution as a reference value. The division processor 133 classifies, when the predetermined condition includes that a distance between the reference value and a power value is less than or equal to a predetermined threshold and when the power value satisfies the predetermined condition, the power information containing the power value into the one of the groups.

With this configuration, frequency distribution, which is a simple technique, enables accurate classification of groups.

When the predetermined condition is satisfied, the division processor 133 preferably classifies power information including the second power value generated in a later time in the time sequence into the same group as power information including the first power value. The predetermined condition includes two requirements. One requirement is that the power values generated in time sequence during the comparison period include a first power value and a second power value, a distance between the first power value and the reference value and a distance between the second power value and the reference value being each less than or equal to the predetermined threshold, the first power value and the second power value being adjacent to each other in the time sequence. The other requirement is that a time difference between a time at which the first power value is generated and a time at which the second power value is generated falls within a predetermined determination period.

With this configuration, even when the power value is not constant and varies over time, whether the power values are treated as the same group or as different groups can be automatically determined.

The electric circuit preferably includes the plurality of branch circuits 32 branched off from the main circuit 31, and the meter 30 is preferably configured to measure the power value of each of the branch circuits 32. The analysis unit 13 preferably sets the threshold and the determination period for each of the branch circuits 32.

With this configuration, the threshold and the determination period are set for each of the branch circuits 32. Therefore, groups can be classified with high accuracy. For example, a small threshold may be set for the living room in which a plurality of electric appliances 20 are highly likely connected to a branch circuit 32, and a large threshold may be set for the kitchen in which the number of electric appliances 20 connected to the branch circuit 32 is relatively small.

The power usage estimation device 10 preferably includes the calculation unit 17 and the output unit 18. The calculation unit 17 obtains an electricity tariff of each of the groups and consumed energy of each of the groups from the power information of each of the groups and a unit price of the electricity tariff. The output unit 18 associates the electricity tariff and the consumed energy obtained by the calculation unit 17 with the group to output the electricity tariff and the consumed energy.

With this configuration, a user can know the consumed power value and the electricity tariff of each group.

The program of the present embodiment enables a computer to function as any of the above-described power usage estimation devices.

This program classifies the pieces of power information (measured power value) into groups, and therefore, the consumed power value of each electric appliance 20 does not have to be known in advance, and it becomes possible to simply estimate that an electric appliance 20 of which amount of power consumption is connected. Moreover, comparison of pieces of power information of each group on a plurality of days having different attributes with each other enables estimation of power usage of apparatus which is used seasonally or apparatus used irrespective of the day.

Note that the above-described embodiment is a mere example of the present invention. Therefore, the present invention is not limited to the above-described embodiment. Even in configurations other than that illustrated in this embodiment, various modifications may be made depending on design and the like without departing from the technical idea of the present invention.

1. A power usage estimation device, comprising:
an acquisition unit configured to acquire, from a meter, power values of power passed through an electric circuit of a consumer facility;
a first storage unit configured to store pieces of power information each including a corresponding one of the power values acquired by the acquisition unit and a day and a time which are associated with the corresponding one of the power values;
an analysis unit configured to classify one or more pieces of power information satisfying a predetermined condition, of the pieces of power information stored in the first storage unit per day, into one of groups which corresponds to the predetermined condition;
a second storage unit configured to store the groups into which the pieces of power information are classified by the analysis unit; and
an estimation unit configured to estimate power usage of the electric circuit by comparing the one or more pieces of power information of the groups stored in the second storage unit between a plurality of days having different attributes.

2. The power usage estimation device according to claim 1, wherein
the estimation unit is configured to
obtain a stationary range of a feature amount extracted from transitions of the power values of each of the groups on a plurality of days having identical attributes, and
estimate the power usage of the electric circuit by comparing the stationary range with the feature amount extracted on each of the days.

3. The power usage estimation device according to claim 1, wherein
each of the attributes is at least one of a day of a week, a month, a season, an outdoor temperature, and weather.

4. The power usage estimation device according to claim 1, wherein
the analysis unit includes
a statistical processor configured to obtain a frequency distribution of the power values included in the pieces of power information during a predetermined comparison period stored in the first storage unit;
a reference value setting unit configured to define a most frequent value of the power values in the frequency distribution as a reference value; and
a division processor configured to classify, when the predetermined condition includes that a distance between the reference value and a power value is less than or equal to a predetermined threshold and when the power value satisfies the predetermined condition, the power value into the one of the groups.

5. The power usage estimation device according to claim 4, wherein
the predetermined condition includes that
the power values generated in time sequence during the comparison period include a first power value and a second power value, a distance between the first power value and the reference value and a distance between the second power value and the reference value being each less than or equal to the predetermined threshold, the first power value and the second power value being adjacent to each other in the time sequence, and
a time difference between a time at which the first power value is generated and a time at which the second power value is generated falls within a predetermined determination period, and
the division processor is configured to, when the predetermined condition is satisfied, classify power information including the second power value generated in a later time in the time sequence into a same group as power information including the first power value.

6. The power usage estimation device according to claim 5, wherein
the electric circuit includes a plurality of branch circuits branched off from a main circuit,
the meter is configured to measure the power value of each of the branch circuits, and
the analysis unit is configured to set the threshold and the determination period for each of the branch circuits.

7. The power usage estimation device according to claim 1, further comprising:
a calculation unit configured to obtain an electricity tariff of each of the groups and consumed energy of each of the groups from the power information of each of the groups and a unit price of the electricity tariff; and
an output unit configured to associate the electricity tariff and the consumed energy obtained by the calculation unit with the group to output the electricity tariff and the consumed energy.

8. A program configured to enable a computer to function as the power usage estimation device according to claim 1.
